(19) United States
(12) Patent Application Publication
(10) Pub. No.: US 2018/0352722 A1
(43) Pub. Date: Dec. 13, 2018

(54) A DISTRIBUTOR DEVICE OF MATERIAL FOR AGRICULTURAL MACHINES

(71) Applicant: MATERMACC S.P.A., San Vito Al Tagliamento (PN) (IT)

(72) Inventors: Andrea BEDOSTI, BOLOGNA (IT); Massimo ZUBELLI, Gualtieri (RE) (IT); Michele TRIVILLIN, San Vito al Tagliamento (PN) (IT); Claudio BENASSI, MIRANDOLA (MO) (IT)

(21) Appl. No.: 15/769,366

(22) PCT Filed: Oct. 11, 2016
(86) PCT No.: PCT/IB2016/056068

§ 371 Date: Apr. 19, 2018

(30) Foreign Application Priority Data
Oct. 19, 2015 (IT) 102015000063033

(51) Int. Cl. A01C 7/08; A01C 7/04

(52) U.S. Cl. CPC A01C 7/082; A01C 7/046

(57) ABSTRACT

A device (100) for distributing material for an agricultural machine (10) comprising: a chamber (110) provided with an inlet (105) and an outlet (106) for the material to be distributed; pneumatic means for generating a depression in the chamber (130); a distributor element (120) housed in the chamber (110) and suitable to receive the material due to the depression and transfer it from the inlet (105) to the outlet (106) of the chamber (110); the pneumatic means comprise an aspirating conduit (130) and a Venturi tube (133) connected to the aspirating conduit (130) and suitable to connect the aspirating conduit (130) with an exhaust pipe (21) of an engine so as to create a depression in the chamber (110).

### TECHNICAL FIELD

The present invention regards a device for distributing material for agricultural machines.

In particular, the invention regards a pneumatic device for distributing material and an agricultural machine comprising said device.

### PRIOR ART

As known, driven or self-propelled agricultural machines for distributing material such as fertiliser or seeds for instance, are widely used in agriculture.

A typical example of such agricultural machines are precision sowers which comprise a plurality of sowing units supported by a frame which rests against the ground by means of at least one wheel and it is connected to a driving unit for driving the sowing machine.

Each sowing unit comprises at least one distributor device provided with a chamber having an inlet and an outlet for the seeds to be distributed and placed in fluid connection with a fan, mechanically connected to a power take off of the driving unit, for generating a depression inside the chamber.

In addition, inside the chamber there is housed a distributor element, suitable to receive the material due to the depression and transfer it from the inlet to the outlet of the chamber.

Therefore, such machines require the presence of a fan which enables the depressurisation of the distribution chamber.

The fan for creating depression in the distribution chamber absorbs energy from the driving unit through a power take off, for example through a cardan shaft, thus having an impact on the consumption of the engine by the driving unit.

In addition, the use of the fan increases the costs of manufacturing the agricultural machine which is thus considerably complex in terms of design, management and maintenance.

An object of the present invention is to overcome the aforementioned drawbacks of the prior art through a solution that is simple, rational and inexpensive.

These objects are attained by the characteristics of the invention, which are outlined in the independent claim. The dependent claims outline preferred and/or particularly advantageous aspects of the invention.

### DESCRIPTION OF THE INVENTION

In particular, an embodiment of the invention provides a device for distributing material for an agricultural machine comprising: a chamber provided with an inlet and an outlet for the material to be distributed; pneumatic means for generating a depression inside the chamber; a distributor element housed in the chamber and suitable to receive the material due to the depression and transfer it from the inlet to the outlet of the chamber.

According to the invention, the pneumatic means comprise an aspirating conduit and a Venturi tube connected to the aspirating conduit and suitable to connect the aspirating conduit with an exhaust pipe of an engine so as to create a depression in the chamber.

Such solution allows generating a depression in the chamber by exploiting the energy of the engine exhaust gases, for instance from the driving unit, without requiring further energy consumption and obtaining cost saving and positive environmental compact.

In addition, the Venturi tube is an element that is easy and inexpensive to design and manufacture and it does not require particular maintenance interventions given that it has no mobile parts.

In addition, given that they have no mobile parts, the Venturi tubes enable reducing the acoustic impact of the distributor device.

According to an aspect of the invention, the Venturi tube comprises a first tubular element coaxially associable to the exhaust pipe and provided with a choke and a second tubular element associated to the aspirating conduit and connected to the first tubular element substantially at the choke position.

Due to this solution, the Venturi tube may be associated to the exhaust pipe of any engine.

According to a further aspect of the invention, the aspirating conduit is connected to the chamber at an opening thereof, said opening being different and distinct from the outlet for the material.

Thus, the path of the material to be distributed and that of the aspirated air are different from each other, thus the material to be distributed does not come to contact with the environment close to the engine exhaust gases.

According to another aspect of the invention, the device comprises a casing in which the chamber is defined, and on which a through hole is located, connected to a filter for the air aspirated into the casing.

Such solution enables preventing debris and any other material that can be harmful to the device from getting into the chamber.

According to another aspect, the device comprises a perforated grid arranged on the casing and suitable to enable the flow of air between the interior and exterior of the casing.

Such solution enables preventing debris and any other material that can be harmful to the device from getting into the chamber.

According to another aspect of the invention, the distributor element comprises: a distributor disc rotatably housed in the chamber and suitable to draw the material to be distributed in proximity of the chamber inlet and release it in proximity of the chamber outlet during the rotation about the axis thereof, and means for driving the distributor disc in rotation.

Thus, the material is distributed through elements that are easy to design and use and the disc enables a regular and constant dispensing of the material.

Another aspect of the invention provides for that the distributor disc be arranged in the chamber so as to be interposed between the outlet of the material and the aspirating conduit of the pneumatic means.

Thus, thus the distribution disc enables clear separation between the path of the material and the path of the aspirated air and thus also that of the exhaust gases which thus do not come into contact with the material.

According to another aspect of the invention, the device comprises an element interposed between the disc and the aspirating conduit and suitable to interrupt the depression on at least one portion of the distributor disc so as to enable the detaching of the material from the distributor disc.

Thus, the detachment of the material from the disc occurs due to the interruption of the depression without requiring additional mechanical means acting on the material and complicating the designing of the device.

Due to this solution, the agricultural machine is light, smaller and thus easier to handle with respect to known machines that utilise a fan.

In addition, the invention provides a system comprising an agricultural machine according to the invention connected to a driving unit provided with an engine comprising an exhaust pipe in which the Venturi tube is connected to the exhaust pipe.

### BRIEF DESCRIPTION OF THE DRAWINGS

Further characteristics and advantages of the invention will be apparent from reading the flowing description—provided by way of non-limiting example—with reference to the figures illustrated in the attached drawings.

FIG. 1 is an axonometric view of the device according to the invention;

FIG. 2 is a top view of the device.

FIG. 3 is section III-III of FIG. 2.

FIG. 4A is section IV-IV of FIG. 2.

FIG. 4B is section IV-IV of FIG. 2 without the distributor disc.

FIG. 5 is section V-V of FIG. 2.

FIG. 6 is a section according to an axial plane of the fitting.

FIG. 7 is an enlargement of detail VII of FIG. 6.

FIG. 8 is an axonometric view of a sowing unit comprising the device according to the invention.

FIG. 9 is a lateral view of the sowing unit of FIG. 8.

FIG. 10 is a lateral view of a system comprising a driving unit and an agricultural machine according to the invention.

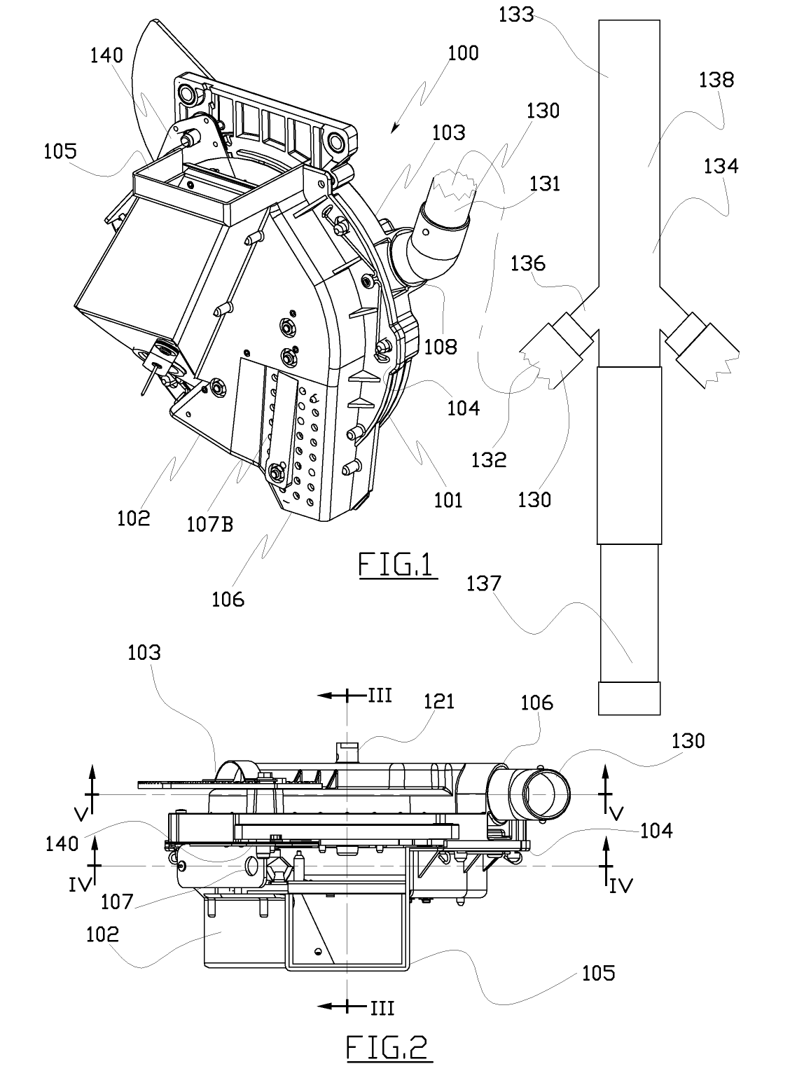

### BEST EMBODIMENT OF THE INVENTION

With particular reference to such figures, an agricultural machine for distributing material, for instance a precision pneumatic sowing machine, is indicated in its entirety with 10.

In the preferred embodiment (and shown in the figures), the agricultural machine 10 is associable to a driving unit 20, for example a tractor, so as to be driven forward along an advancement direction A for sowing the ground.

As known, the driving unit 20 comprises an internal combustion engine provided with an exhaust pipe 21, projecting from the driving unit 20 for releasing the gases produced by the combustion into the atmosphere.

According to another embodiment (not shown) the agricultural machine 10 could be of the self-propelled type and comprising at least one internal combustion engine, provided with an exhaust pipe 21, fixed to a frame of the agricultural machine 10 and suitable to drive at least one wheel or other means that allow the movement along an advancement direction.

The agricultural machine 10 comprises a frame 11 to which there are connected a pair of wheels 12 which enable supporting and moving the agricultural machine 10.

To the frame 11, for example at the upper part thereof, there may be fixed a fertiliser spreader tank 13 provided with lower nozzles from which a fertiliser spreader unit 14, for example of the pneumatic type, draws a measured amount of fertiliser to be spread on the ground during the advancement of the agricultural machine 10 along the advancement direction A.

The agricultural machine 10 comprises a, or a plurality of, sowing unit/s 30 fixed to the frame 11, and in particular aligned and equally spaced along a direction substantially perpendicular to the advancement direction A.

Each sowing unit 30 comprises a substantially rigid framework 31, for example metallic, which is fixed to the frame 11 of the agricultural machine 10, and it is suitable to support a respective tank 32, which contains a plurality of seeds to be dispensed on the ground.

In addition, on the framework 31 there is mounted a distributor device 100 to be described further in detail hereinafter and which is connected to the tank 32 (to the outlet mouth thereof) and it is suitable to dispense a measured amount of seeds, for example one seed at a time.

In addition, the framework 31 supports a drilling element 33, for example of the disc or double disc or “harrow” type. For example, the drilling element 33 is arranged beneath the framework 31, so as to come into contact with the ground and it is arranged upstream of the point where the seed dispensed by the device 100 drops in the advancement direction of the agricultural machine 10 along the advancement direction A.

In addition, the framework 31 supports a unit 34 for closing the furrow made on the ground by the drilling element 33, which is for example fixed in an adjustable fashion, height-wise for example, to the framework 31 and it is arranged downstream of the point where the seed drops in the advancement direction of the agricultural machine 10 along the advancement direction A.

The closing unit 34 for example comprises a plurality of rotary discs inclined with respect to each other and with rotational axis inclined with respect to the horizontal.

The dispenser device 100 comprises a casing 101 fixed to the framework 31 of the sowing unit 30 internally hollow and adapted to define—therein—a chamber 110 suitable to receive an element for distributing the material to be distributed as better described hereinafter.

The casing 101 is for example defined by a first half-shell 102 and a second half-shell 103 suitable to be joined to each other to define the chamber 110.

In particular, each half-shell 101,102 is defined by a substantially hollow body and it is suitable to be arranged with the concavity facing towards the other half-shell 101,102.

In addition, each half-shell 101,102 comprises a perimeter flange 104 suitable to be coupled and fixed by means of suitable fixing means, per se known, to the perimeter flange 104 of the other half-shell 102,103, for example by interposing a sealing gasket.

In use, the casing 101 is suitable to be arranged in a vertical position in which the plane of the perimeter flanges 104 is substantially parallel to the vertical; from now henceforth, the terms upper and lower will be used with reference to such position.

The first half 102 comprises a loading hopper 105 obtained in an upper portion thereof and associated to the tank 32, overlying the device 100, for the input of the seeds into the chamber 110.

The loading hopper 105 is defined by a chute faced towards the lower portion of the first half-shell 102.

The first half-shell 102 further comprises a lower projection suitable to define, combined with a similar part of the second half-shell 103, a channel 106 for the output of the seeds from the chamber 110.

The channel 106 for the output of seeds is connected to a pipe, not shown, provided with an end distal from the chamber 110 and arranged in proximity of the drilling element 33 to release the seed into the furrow made by the drilling element 33.

Furthermore, the first half-shell 102 comprises a through hole 107, for example obtained in an upper portion of the first half-shell 102, for the input of the atmospheric air aspirated through suitable pneumatic means to be better described hereinafter.

The through hole 107 is advantageously connected, by means of a suitable pipe, to an external filter 107A with respect to the casing 101.

In addition, the first half-shell 102 comprises a further opening closed by a perforated grid 1078 which allows the flow of air between the interior and the exterior of the chamber 110 (in particular the intake of air into the chamber 110) during the operation of the distributor device 100.

The second half-shell 103 comprises an opening 108, for example obtained in a perimeter portion of the second half-shell 103, to which there are connected said pneumatic means for the generation of a depression in the chamber 110, as better described hereinafter.

Preferably, the opening 108 is obtained in a position such to be located in a distal position with respect to the output channel 106 when the two half-shells 102,103 are joined to each other, so that the opening 108 and the output channel 106 are different and distinct with respect to each other.

In the second half-shell 103 there is obtained a diversion channel 109, for the air aspirated by the pneumatic means, placed in communication with the opening 108.

The diversion channel 109, lies on a plane substantially parallel to the plane of the flange 104 and it comprises an end at the opening 108 and an opposite end facing towards the lower portion (in use) of then second half-shell 103, i.e. the portion of the second half-shell 103 proximal to the output channel 106 when the two half-shells are joined 102,103 to each other.

The diversion channel 109, for example with rectangular cross-section, is placed in communication with the opening 108 of the second half-shell 103 at one end, and open on a plane substantially perpendicular to the plane of the flange 104 at the other end, while it is closed on the plane parallel to the plane of the flange 104, for example by a plate 109A.

In the embodiment shown in the figures, the diversion channel 109 is substantially shaped to form a circumference arc and it follows the perimeter edge of the concavity of the second half-shell 109.

In addition, in the embodiment shown in the figures, the diversion channel 109 comprises a cross-section tapered towards the end distal from the opening 108.

Advantageously, the casing 101 may be made of plastic material.

The distributor device 100 comprises a disc 120 for distributing the material housed in the chamber 110 and suitable to draw the material and transfer it from the loading hopper 105 to the output channel 106.

The distributor disc 120 is rotatably housed in the chamber 110 and, in particular, it is coaxially connected to a rotary shaft 121 projecting from the casing 101 and in turn connected to suitable drive means. In the embodiment shown in the figures, the rotary shaft 121 projects from a central portion of the second half-shell 103.

The distributor disc 120 is housed in the chamber 110 so as to lie on a plane parallel to the plane of the flanges 104 and it substantially occupies the entire overall dimension of the chamber 110 on said plane, i.e. the edges of the distributor disc are arranged substantially flushed with respect to the interior walls of the chamber 110.

In addition, the distributor disc 120 is housed in the chamber 110 substantially at the flanges 104, i.e. at a distance from the bottom parts of the concavities of the half-shells 102,103.

In particular, the distributor disc 120 divides the chamber 110 into two environments 111,112 including a first environment 111 placed in communication with the loading hopper 105 and the output channel 106 and a second environment 112 placed in communication with the opening 108 and in which the diversion channel 109 is housed.

The distributor disc 120 is for example defined by a disc, for example made of metal or plastic material, comprising a first series of through holes 122,123 arranged circumferentially with respect to the distributor disc 120.

In particular, the distributor disc 120 comprises a series of first holes 122 arranged proximal to the edge of the distributor disc 120, and a series of second holes 123 arranged distal from the edge of the disc with respect to the first holes 122.

The first holes 122 are equally spaced from each other and they have a diameter smaller than the minimum dimension of the material to be distributed, for example that of the seeds. Similarly, also the second holes 123 are equally spaced from each other.

At least one part of the first holes 122 (for example at least one) are superimposed to the diversion channel 109 when the distributor disc 120 is housed in the chamber 110.

In particular, each first hole 122 is suitable to be superimposed to the diversion channel 109 during the rotation of the distributor disc 120 about the axis thereof.

The distributor disc 120 is fixed integrally joined and coaxial to a driving disc 124 fitted on the rotary shaft 121, and in particular, the distributor disc 120 and the driving disc 124 are fixed to each other in succession along the axis of the rotary shaft 121, for example at an end thereof, with the distributor disc 120 facing towards the first half-shell 102 and the driving disc 124 facing towards the second half-shell 103.

The distributor disc 120 and the driving disc 124 are fixed to each other by interposing a sealing gasket.

The driving disc 124 comprises, for example, spokes integrally joined to the rotary shaft 121 and provided with a plurality of pins 125 arranged circumferentially and projecting along the direction parallel to the axis of the rotary shaft 121.

The pins 125 are suitable to be inserted into the second holes 123 of the distributor disc 120 so as to hold the distributor disc 120, for example by interference.

In particular, the pins 125 are suitable to project from the distributor disc 120 towards the first half-shell 102.

The driving disc 124 has a diameter smaller than the diameter of the distributor disc 120 and, in particular, the first holes 122 of the distributor disc 120 project beyond the perimeter edge of the driving disc 124.

The rotary shaft 121 is connected to transmission means suitable to take motion from the wheels 12 of the agricultural machine 10, as known to a man skilled in the art, or from other motion transformation means so as to define the distance between the seeds dispensed along the advancement direction as a function of the advancement speed of the agricultural machine 10.

The device 100 may also comprise a selector device 140 comprising a substantially flat body arranged between the first and the second half-shell 102,103 and partly superimposed on an external portion of the distributor disc 120, in particular superimposed on the surface of the distributor disc 120 faced towards the first half-shell 102.

In addition, the selector device 140 is hinged to the casing with the possibility to perform slight rotations about an axis substantially parallel to the plane of the flange 104, and it comprises means for adjusting the position of the selector device 140 with respect to the distributor disc 120, such as for example an eccentric pin 141 housed in a respective slot.

The selector device 140 comprises a serrated edge 142 faced towards the interior of the chamber and arranged proximal to the first holes 122 of the distributor disc 120. The serrated edge 142 is suitable to impact against the seeds driven by the distributor disc 120 so as to limit the number of driven seeds as better described hereinafter.

The device 100 further comprises pneumatic means for generating a depression inside the chamber 110, comprising an aspirating conduit 130 associated to the chamber 110 at the second opening 108.

The aspirating conduit 130 is defined, for example, by a flexible rubber pipe having a first end 131 fixed to the second opening 108 of the chamber 110 and a second end 132 connected to the exhaust pipe 21 of the driving unit 20 by means of a Venturi tube 133.

The Venturi tube (33 comprises a first tubular element 134 coaxially associable to the exhaust pipe 21 of the driving unit 21 and provided with a choke 135, and a second tubular element 136 associated to the aspirating conduit 130 and fixed to the first tubular element 134 in proximity (downstream) of the choke (135) position.

According to an embodiment, the Venturi tube 133 comprises a first tubular element 134 and a plurality of second tubular elements 136, in which each second tubular element 136 is connected to the aspirating conduit 130 of a respective distribution device 100 of the agricultural machine 10.

In the embodiment shown in the figures, the first tubular element 134 and the second tubular element 136 are fixed to each other with mutually incident axes, for example with an acute angle smaller than 90°.

The first tubular element 134 of the Venturi tube 133 has a section substantially similar to the section of the exhaust pipe 21 of the driving unit 20 and it is suitable to be coaxially fitted into the free end of the exhaust pipe 21.

In the embodiment shown in the figures, the first tubular element 134 of the Venturi tube 133 is defined by a first section 137 and a second section 138 coaxially fixed to each other and substantially aligned along the longitudinal axis thereof.

The first section 137 of the first tubular element 134 is for example cylindrical shaped and it comprises a first end 137A (upstream of the choke 135) suitable to be fitted into the free end of the exhaust pipe 21 and an opposite second end 1378 fixed to the second section 138.

In particular, the first end 137A of the first section 137 of the first tubular element 134 may be removably fixed to the free end of the exhaust pipe 21, for example by means of clamp elements or other fixing means.

The second end 1378 of the first section 137 of the first tubular element 134 is tapered and inserted into the second section 138 and sealingly fixed thereto, for example by welding.

In particular, the second end 137B of the first section 137 is substantially frusto-conical shaped so as to define the choke 135.

The second section 138, also cylindrical-shaped, comprises an end 138A constrained, for example welded, to the second end 137B of the first section and an opposite free end 138B (downstream of the choke 135).

The second tubular element 136 is substantially cylindrical-shaped and it comprises a first end 136A fixed to the end of the aspirating conduit 130 distal from the chamber 110 and a second end 1368 fixed to the second section 138 of the first tubular element 134 so that the first and the second tubular element 134,136 are in fluid communication with respect to each other.

The second end 136B of the second tubular element 136 is fixed to the first tubular element 134 in proximity of the constrained end 138A of the second section 138 of the first tubular element 134 and in particular downstream of the choke 135.

In particular, the second end 1368 of the second tubular element 136 is faced towards the interior of the first tubular element 134 substantially at the choke 135.

As described above, the distributor device 100 operates as follows.

When the agricultural machine 10 is moving, for example drawn by the tractor 20, the exhaust gases exiting from the exhaust pipe 21 of the engine flow through the Venturi tube 133 where, thanks to the choke 135, they are subjected to an acceleration. In particular, the exhaust gases are subjected to an acceleration when flowing from the first section 137 to the second section 138 of the first tubular element 134 and they are released into the atmosphere through the free end 1388 of the second section 138 of the first tubular element 134.

Therefore, due to the Venturi effect, a depression is generated in the choke 135 and thus an intake of air from the chamber 110 through the aspirating conduit 130. The aspirated air flows through the aspirating conduit and, together with the exhaust gases, through the second section 138 of the first tubular element 134 to be released into the atmosphere through the free end 138B of the second section 138. Inside the chamber 110 the depression is transmitted from the second environment 112 to the first environment 111 through the first holes 122.

In addition, during movement, the transmission means take motion from the wheels 12 and transmit it to the distributor disc 120 which thus rotates about the axis thereof at a speed depending on the rotational speed of the wheels 12.

The seeds contained in the tank 32 enter into the chamber 110 through the loading hopper 105 and, in particular, they settle at the bottom of the first environment 111 by gravity.

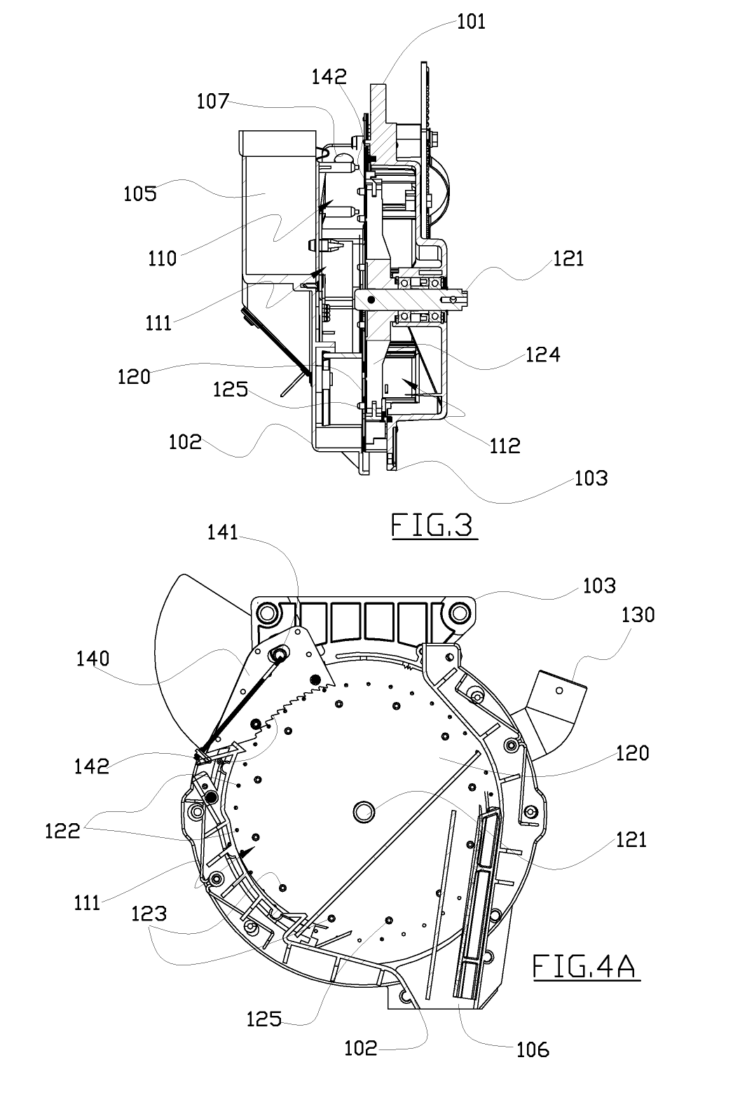

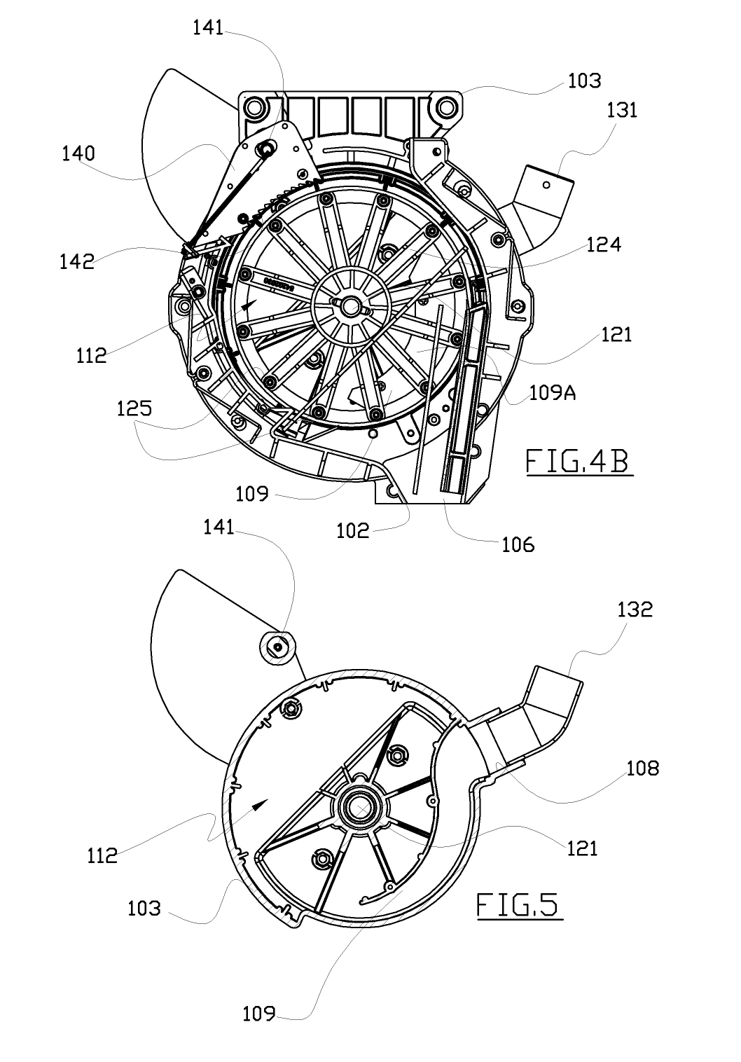

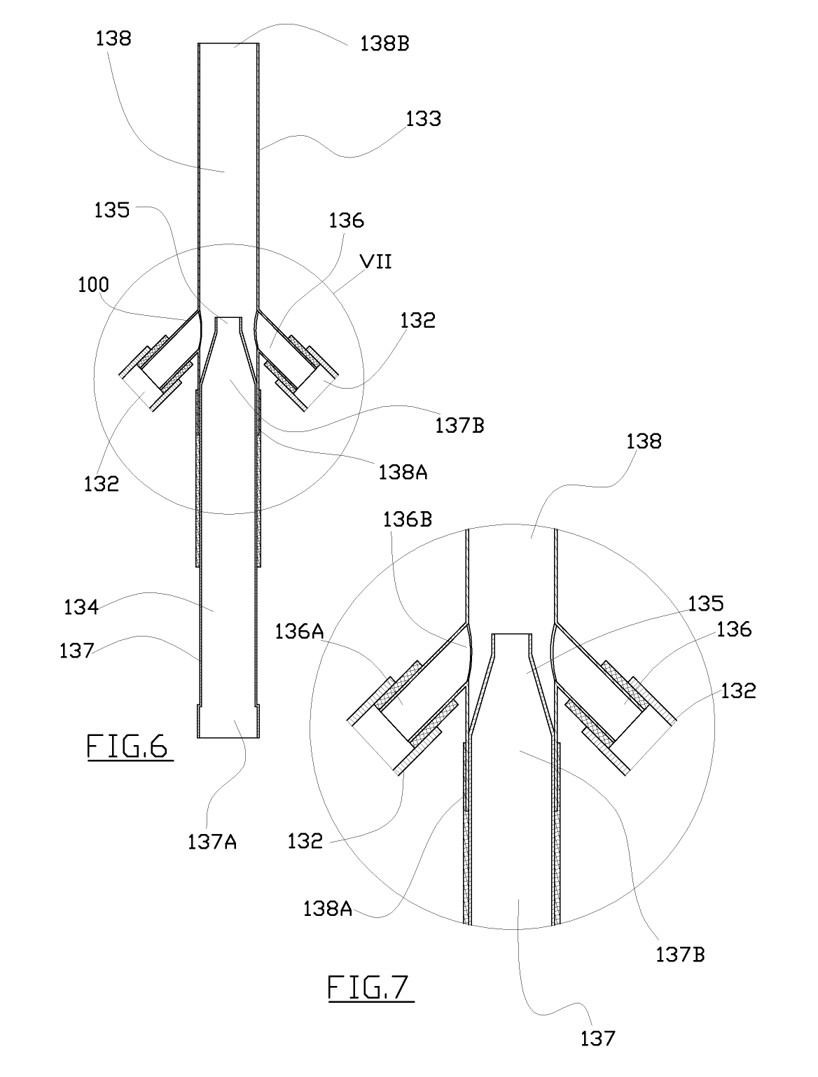

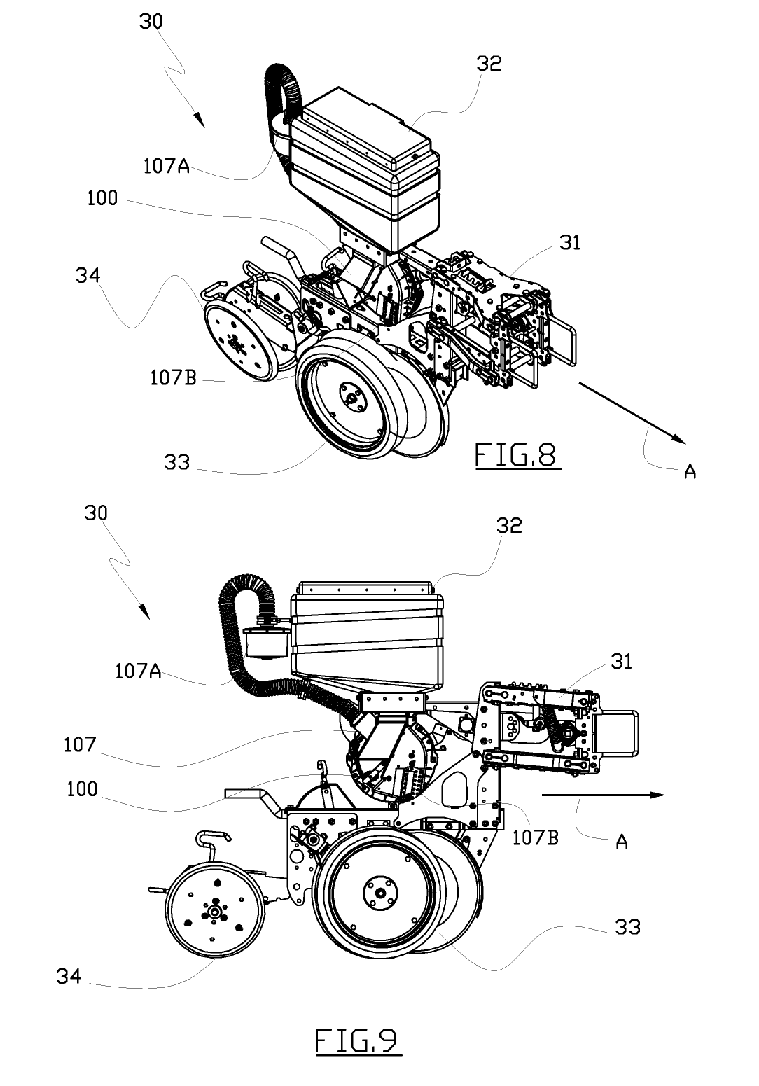

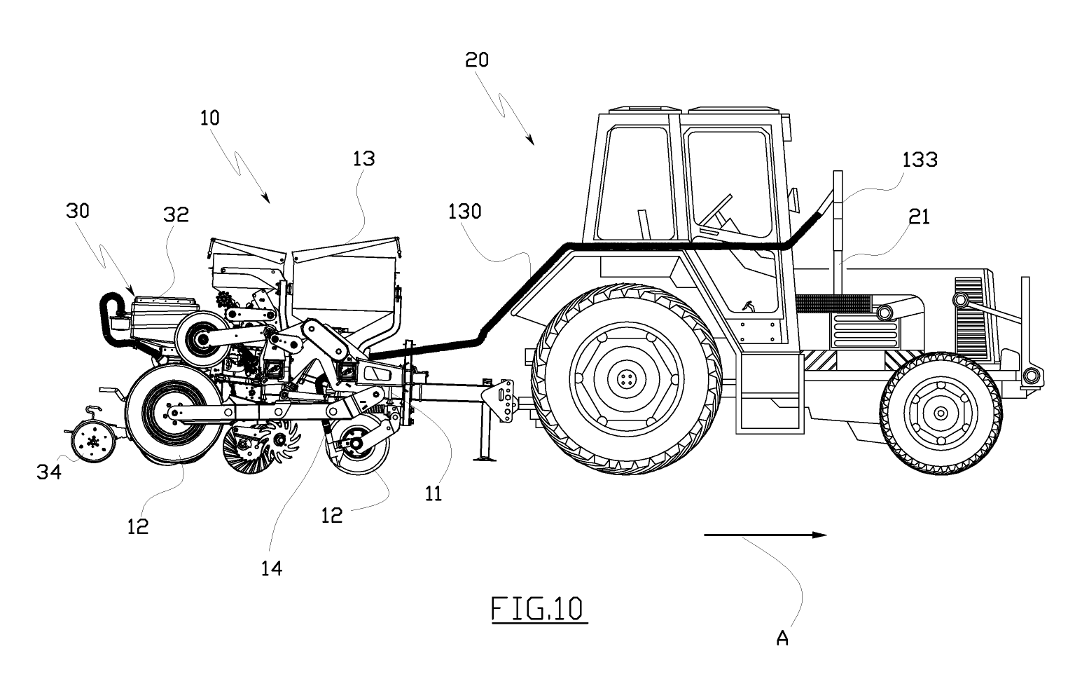

Thanks to the depression created in the chamber 110 by the pneumatic means, the seeds stick to the distributor disc 120, in particular in proximity of the first holes 122, and it drives them from the loading hopper 105 towards the output channel 106 (rotating clockwise with respect to FIG. 4A).

During the rotation of the distributor disc 120, the serrated edge 142 of the selector device 140 and the pins 125 of the driving disc 124 impact against the seeds driven by the distributor disc so as to detach the seeds sticking against the distributor disc 120 with less sticking force, i.e. the seeds sticking in proximity but not at the first holes 122. This enables limiting the number of seeds sticking to each first hole 122 to just one.

When the seed reaches in proximity of the output channel 106, and in particular when the respective first hole 122 is at the diversion channel 109, there lacks the depression which enables the seed to stick to the surface of the distributor disc 120, thus the seed drops into the output channel 106 by gravity.

The invention thus conceived is susceptible to numerous modifications and variants all falling within the inventive concept.

In addition, all details can be replaced by other technically equivalent elements.

Basically, the materials used as well as the shapes and contingent dimensions, may vary according to the needs without departing from the scope of protection of the claims that follow.

1. A device (100) for distributing material for an agricultural machine (10) comprising:
a chamber (110) provided with an inlet (105) and an outlet (106) for the material to be distributed;
pneumatic means for generating a depression inside the chamber (130);
a distributor element (120) housed in the chamber (110) and suitable to receive the material due to the depression and transfer it from the inlet (105) to the outlet (106) of the chamber (110);wherein
the pneumatic means comprise an aspirating conduit (130) and a Venturi tube (133) connected to the aspirating conduit (130) and suitable to connect the aspirating conduit (130) with an exhaust pipe (21) of an engine so as to create a depression in the chamber (110), wherein
the Venturi tube (133) comprises: a first tubular element (134) coaxially associable to the exhaust pipe (21) and provided with a choke (135) and a second tubular element (136) associated to the aspirating conduit (130) via a first end (136A) thereof and connected to the first tubular element (134) substantially at the choke (135) position, the first tubular element (134) comprising:
a first section (137) having a first end (137A) suitable to be fitted into the free end of the exhaust pipe (21) and an opposite second end (137B) frustoconically shaped so as to define the choke (135), and
a second section (138) in which the second end (137B) is inserted and to which a second end (136B) of the second tubular element (136) is fixed so that the first and the second tubular elements (134, 136) are in fluid communication with respect to each other.

2. The device (100) according to claim 1, wherein the aspirating conduit (130) is connected to the chamber (110) at an opening (108) thereof, said opening (108) being different and distinct from the outlet (106) for the material.

3. The device (100) according to claim 1, further comprising a casing (101) in which the chamber (110) is defined, and on which a through hole (107) is located, connected to a filter (107A) for the air aspirated into the casing (101).

4. The device (100) according to claim 3, further comprising a perforated grid (107B) arranged on the casing (101) and suitable to enable the flow of air between the interior and the exterior of the casing (101).

5. The device (100) according to claim 1, wherein the distributor element comprises:
a distributor disc (120) rotatably housed in the chamber (110) and suitable to transfer the material to be distributed from the inlet (105) to the outlet (106) of the chamber (110) during the rotation about the axis thereof, and
means (121) for driving the distributor disc in rotation.

6. The device (100) according to claim 5, wherein the distributor disc (120) is arranged in the chamber (110) so as to be interposed between the outlet (106) of the material and the aspirating conduit (130).

7. The device (100) according to claim 5, further comprising an element (109) interposed between the distributor disc (120) and the aspirating conduit (130) and suitable to interrupt the depression on at least one portion of the distributor disc (120) so as to enable the detaching of the material from the distributor disc (120).

8. An agricultural machine (10) for distributing material comprising a frame (11) for supporting at least one distributor device (100) according to claim 1.

9. A system comprising an agricultural machine (10) according to claim 8, connected to a driving unit (20) provided with an engine comprising an exhaust pipe (21) to which the Venturi tube (133) is connected.
